(19) United States
(12) Patent Application Publication
(10) Pub. No.: US 2003/0134969 A1
(43) Pub. Date: Jul. 17, 2003

(54) Moisture-crosslinked and filled cable compounds

(75) Inventors: Thomas Schlosser, Inzlingen (DE); Helmut Mack, Rheinfelden (DE); Aristidis Ioannidis, Rheinfelden (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/310,869

(22) Filed: Dec. 6, 2002

(30) Foreign Application Priority Data
Dec. 6, 2001 (DE) 101 59 952.8

(51) Int. Cl. C08J 3/00

(52) U.S. Cl. 524/588

(57) ABSTRACT

Compositions comprising at least one liquid or carrier-bound, unsaturated organosilane, at least one free-radical generator (FRG), an optional crosslinking catalyst, a thermoplastic base polymer and a reinforcing, extending, or flame-retardant mineral filler provide moisture-crosslinked, filled cable compounds having superior properties compared to conventional cable compounds.

### FIELD OF THE INVENTION

The present invention is a cable compound comprising a liquid unsaturated organosilanes or carrier-supported unsaturated organosilane, a thermoplastic base polymer, and a reinforcing, extending, or flame retardant mineral filler. The invention further relates to a method of preparing such cable compounds, and also to cables with insulation or sheathing made from such cable compounds.

For the purposes of the present invention, cable compounds are defined as mixtures which comprise a thermoplastic base polymer and also inorganic or mineral reinforcing, extending, or flame-retardant fillers, and which are used in electrically insulating sheathing for metallic conductors.

### BACKGROUND OF THE INVENTION

It is known that the addition of functionalized organylorganyloxysilanes to fillers makes it easier to disperse the filler in a base polymer, and improves adhesion between the base polymer and the filler. In this context, functionalized organylorganyloxysilanes are silanes which have an organic radical containing a functional group bonded via a carbon atom to the silicon atom. The easier dispersion of thus treated filler in the base polymer may be attributed to the hydrophobicization of the surface of the filler particles by the silane. The improved adhesion of the hydrophobicized filler to the base polymer provides better mechanical properties in cable sheathing.

It is also known that when preparing moisture-crosslinkable polymers, silanes can be grafted onto polymer chains in the presence of a free-radical generator (FRG), and that the moisture-crosslinking may then be carried out after shaping the polymer into the desired form. Processes of this type called the Sioplas® process (DE 19 63 571 C3, DE 21 51 270 C3) and the Monosil® process (DE 25 54 525 C3) are known. The polymers are modified chemically by the coupling (grafting) of unsaturated silane esters to a polymer chain via a free-radical addition reaction. This process involves a first step of homogenizing the starting materials. In this step, no degradation of the FRG is desirable. The subsequent decomposition of the FRG is controlled by means of temperature-controlled processing. Finally, the individual polymer chains are crosslinked by hydrolysis of the silane ester groups, and condensation of the silanol units thus formed. This final crosslinking is accelerated by a crosslinking catalyst, and carried out in a known manner, either in a water bath or in a steam bath, or initiated by atmospheric moisture at ambient temperature (ambient curing). Whereas in the Monosil process, the cross-linking catalyst is added before the first step of processing is complete, in the Sioplas process the addition of the crosslinking catalyst does not take place until the second step has begun. The moisture-crosslinking of unfilled polymers using hydrolyzable unsaturated silanes is used worldwide for producing cables, pipes, foams, etc. The crosslinking of unfilled polymers brings about a marked increase in the heat resistance of the insulation (compared with uncrosslinked insulation material made from polyolefins), and even if a short circuit occurs, the insulation material can withstand brief temperature peaks within the insulation, thus maintaining the integrity of the cable insulation. However, using unsaturated organosilanes to produce moisture-crosslinked and filled cable compounds has not hitherto been described.

Liquid additives can sometimes be difficult to use because conventional weighing and metering equipment for small amounts of additives is designed solely for solids. Small amounts of liquid components therefore sometimes have to be manually weighed and metered. This generally entails relatively high costs and is an additional source of error in preparing a composition.

One known solution for this problem is to bind liquid functional organosilanes to highly adsorbent or highly absorbent solids, which then become “dry liquids” and can readily be weighed and metered using conventional equipment.

For example, DE 195 03 779 A1 describes a combination of silica and trans-polyoctenamer as a carrier for liquid rubber chemicals, including vinyl- and mercaptosilanes, and also sulfur silanes.

DE 44 35 311 A1 describes what are called reinforcing additives made from oligomeric and/or polymeric sulfur-containing organylorganyloxysilanes and from a carrier which is a carbon black of low, medium, and/or high activity. These additives are suitable for use in rubber mixtures or rubber compositions, and also in polymer mixtures. However, in the two above-mentioned applications, no mention is made of cable compounds.

EP 0 426 073 B1 discloses a process in which a base polymer, a spongy polymer, or a swellable polymer with a (meth)acryloxy-functional organosilane present therein is mixed with a substance supplying free radicals, and the mixture is melted and homogenized. This process, too, is not intended for preparing moisture-crosslinkable, filled cable compounds. WO 97/07165 teaches that solid mixtures prepared from functional organosilanes and from certain large-surface-area silicas with low surface energy can be used, inter alia, in insulation for wires and cables.

The use of functional organylorganyloxysilanes on carriers as an adhesion promoter in mineral-filled compounds is also known, for example in what are called HFFR compounds (HFFR =halogen-free flame-retardant) for halogen-free flame retardancy applications (EP 1 063 655 A1). HFFR compounds are generally used in the form of pellets for producing filled cables. However, these filled compounds, where appropriate comprising silane, have the disadvantage of having no heat resistance.

It is an object of the present invention to provide a method of producing filled cable compounds, i.e. filled cables, in particular for halogen-free flame retardancy applications, having improved heat resistance.

The present invention achieves this object in the manner described below.

### SUMMARY OF THE INVENTION

In a first embodiment, liquid, unsaturated organosilanes or the corresponding organosilane-containing preparations, and other components present, such as a FRG and a crosslinking catalyst, provide moisture-crosslinked filled cable compounds. The resulting cables have markedly higher heat resistance than uncrosslinked HFFR compounds.

In a second embodiment, the liquid unsaturated organosilanes are used in the form of a “dry liquid” supported on a carrier, such as fumed silica, precipitated silica, Ca silicate, porous polymers, waxes, or carbon black, for preparing crosslinked filled cable compounds. By supported, we mean that the unsaturated organosilanes are adsorbed on, absorbed in, physically or chemically bonded to, or encapsulated by the carrier.

In a third embodiment, the unsaturated organosilane is vinyltriethoxysilane (VTEO). When VTEO is used, the frequently encountered and disadvantageous formation of foam, bubbles, or an inhomogeneous surface can be markedly reduced or completely eliminated.

In the method and compositions of the present invention, therefore, at least one liquid or carrier-bound unsaturated organosilane, or a preparation which comprises (i) at least one liquid or carrier-bound, unsaturated organosilane, (ii) at least one peroxide, and (iii) where appropriate a crosslinking, hydrolysis, or condensation catalyst (also described by the abbreviated term crosslinking catalyst), may be used to prepare a moisture-crosslinked and filled cable compound. This cable compound comprises a thermoplastic base polymer having polar or non-polar functional groups (described hereinafter by the abbreviated term thermoplastic base polymer) and a reinforcing, extending, or flame-retardant inorganic or, respectively, mineral filler (also described hereinafter by the abbreviated term mineral filler).

In order to prepare a moisture-crosslinked, filled cable compound according to the present invention, i.e. producing a corresponding cable or a cable sheathing by extrusion, it is preferable to use the following starting components:

(a) at least one thermoplastic base polymer, an FRG, a mineral filler, a crosslinking catalyst, and an unsaturated organosilane, or

(b) at least one thermoplastic base polymer, a mineral filler, a crosslinking catalyst, and an organosilane and FRG-containing preparation, or

(c) at least one thermoplastic base polymer, a mineral filler, and an organosilane-, FRG-, and crosslinking-catalyst-containing preparation, or

(d) at least one prefilled, and where appropriate, silane-containing thermoplastic base polymer compound, an FRG,

a crosslinking catalyst, and an unsaturated organo-silane, or

(e) at least one prefilled, and where appropriate, silane-containing thermoplastic base polymer compound, a crosslinking catalyst, and an organosilane- and FRG-containing preparation, or

(f) at least one prefilled, and where appropriate, silane-containing thermoplastic base polymer compound, and an organosilane-, FRG-, and crosslinking-catalyst-containing preparation.

The present invention therefore also provides a process for producing a moisture-crosslinked, filled cable compound with improved heat resistance, by

introducing at least one thermoplastic compound and one mineral filler, or at least one prefilled, and where appropriate, silane-containing thermoplastic compound, and

at least one crosslinking catalyst, at least one FRG, and at least one unsaturated organosilane, or a corresponding preparation made from the above-noted components: an unsaturated organosilane, FRG, and/or crosslinking catalyst, to an extrusion unit, and, where appropriate, adding other components,

extruding, where appropriate with the introduction of a metallic conductor or conductor bundle, and

crosslinking the extrudate in the presence of moisture.

The present invention also provides cables whose metallic conductors have been insulated using a moisture-crosslinked and filled cable compound of the present invention, or whose pre-insulated lead/conductor bundles have been sheathed thereby, and may be prepared by the method of the present invention.

For the purposes of the present invention, unsaturated organosilanes suitable for grafting onto a polymer and then moisture-crosslinking, and therefore suitable for preparing moisture-crosslinked and filled cable compounds of the present invention, have the following formula:

H₂C═C(R′)(COO)ₓ(CₙH₂ₙ)_{y}SiR₃

where

R′ is hydrogen or a methyl group;

x is 0 or 1, and y is 0 or 1, with the proviso that y is 1 if x is 1; and

n is an integer from 1 to 12;

the groups R are identical or different, and R is a group selected from the series alkoxy having from 1 to 12 carbon atoms, such as methoxy, ethoxy, aryloxy, e.g. phenoxy, aralkyloxy, e.g. benzyloxy, aliphatic acyloxy having from 1 to 12 carbon atoms, e.g. acetyloxy, oximo, alkylamino, arylamino, or a linear, branched or cyclic alkyl group having from 1 to 6 carbon atoms, and not more than one group R of the three groups R is alkyl, and at least one group R of the three groups R is a hydrolyzable organic group.

Particularly preferred examples of unsaturated organo-silanes suitable for the method and composition of the present invention are: vinyltrimethoxysilane (VTMO), vinyltriethoxysilane (VTEO), vinyl triisopropoxysilane, allyltriethoxysilane, vinyltri-n-butoxysilane, 3-methacryloxypropyltri-methoxysilane (MEMO), and mixtures thereof.

Preferred organosilanes suitable for preparing moisture-crosslinked and filled cable compounds contain either a vinyl group or a methacrylic group, since both groups are reactive toward free radicals and are suitable for grafting onto a polymer chain, DYNASYLAN® VTMO, VTEO, and MEMO are particularly suitable organosilanes.

According to the method of the present invention, unsaturated organosilanes may also be used in combination with alkylalkoxysilanes, fluoroalkylalkoxysilanes, and/or aminosilanes, for example propyltrialkoxysilanes, octyltrialkoxysilanes, hexadecyltrialkoxysilanes, tridecafluoro-1,1,2,2-tetrahydrooctyltrialkoxysilanes, 3-aminopropyltrialkoxysilanes, the alkoxy groups being in particular methoxy or ethoxy, for example. However, other alkoxy groups (e.g., propyloxy, butyloxy, etc.) are also suitable.

The amount of unsaturated organosilane used in the method and composition of the present invention is usually close to the minimum amount needed to achieve the desired degree of crosslinking. The amount of hydrolyzable unsaturated organosilane is preferably from 0.1 to 10% by weight, preferably from 0.5 to 3% by weight, based on the total weight of the cable compound.

Free-radical generators (FRGs) suitable for preparing the moisture-crosslinked and filled cable compounds of the present invention may generally be any of the organic compounds which can generate free radicals with a suitable half-life time under the prevailing production conditions. Preferred FRGs are organic peroxides and peresters, e.g. tert-butyl peroxypivalate, tert-butyl 2-ethylperoxyhexanoate, dicumyl peroxide, di-tert-butyl peroxide, tert-butyl cumyl peroxide, for example.

The most preferred FRGs are organic peroxides, such as dicumyl peroxide and tert-butyl cumyl peroxide.

The amount of FRG used in the method and composition of the present invention is not critical, but may be selected from within a wide range, e.g. from 0.005 to 0.4% by weight, preferably from 0.01 to 0. 1% by weight, based on the total weight of the cable compound. However, the amount of FRG also depends on the cable compound to be crosslinked, the organosilane, the presence of stabilizer, etc.

The hydrolysis/condensation catalyst of the composition of the present invention usually catalyzes the crosslinking of the extrudate by water. The catalysts may either accelerate the hydrolysis reaction of the grafted silyl groups to give silanols or accelerate the condensation reaction of the silanol groups to give siloxane bonds, or accelerate both. These catalysts may be Lewis acids, e.g. metal carboxylates, such as dibutyltin dilaurate, dioctyltin dilaurate, tin acetate, tin octoate, dibutyltin dioctoate, or else organometallic compounds, e.g. titanium esters and titanium chelates, organic bases, such as triethylamine, hexylamine, dibutylamine, piperidine, or protic acids, such as fatty acids or mineral acids. Preferred catalysts comprise dibutyltin dilaurate (DBTL), dioctyltin dilaurate (DOTL), or tin octoate.

The amount of hydrolysis/condensation catalyst used in the composition and method of the present invention may be, for example from 0.005 to 0.2% by weight, preferably from 0.01 to 0.1% by weight, based on the total weight of the cable compound. Again, the amount of hydrolysis/condensation catalyst is generally dependent on the cable compound to be crosslinked, the organosilane, and, where appropriate, the other components of the composition.

In addition to the unsaturated organosilane, FRG, and crosslinking catalyst, the composition of the present invention may contain other components or additives, for example, these conventionally also used in the moisture crosslinking of unfilled systems. These other components or additives may comprise any type of antioxidant, heat stabilizer, or metal deactivator, and also any type of processing aid, such as silicone oil, stearic acid, waxes, alkylsilanes, fluoroorgano-silanes, or a mixture thereof.

The amount of such extra additives may be, for example, from 0.025 to 0.5% by weight, preferably from 0.05 to 0.2% by weight, based on the total weight of the cable compound. Again, the amount of additives generally depends on the cable compound composition, the organosilane, and, where appropriate, the other components of the composition.

Suitable carriers for the organosilanes of the present invention may be selected from any of a wide variety of materials conventionally used as carriers. Specific preferred carriers are, for example:

Fumed silica, produced on an industrial scale by continuous hydrolysis of silicon tetrachloride in a hydrogen/oxygen flame. In this process, the silicon tetrachloride evaporates and then reacts spontaneously and quantitatively within the flame with the water derived from the hydrogen/oxygen reaction. Fumed silica is an amorphous modification of silicon dioxide, taking the form of a bluish loosely packed powder. The particle size is usually a few nanometers, and the specific surface area is therefore large, generally from 50 to 600 m²/g. Vinylalkoxysilanes/vinylalkoxysilane mixtures are generally adsorbed on fumed silica.

Precipitated silicas are generally prepared by neutralizing sodium water glass solutions with inorganic acids under controlled conditions. The silica is then removed from the liquid phase, rinsed, and dried to give a crude product, which is finely ground, e.g. in a steam-jet mill. Precipitated silica is also a substantially amorphous silicon dioxide, but its specific surface area is generally from 50 to 150 m²/g. Unlike fumed silica, precipitated silica has some porosity (about 10% by volume). Vinylalkoxysilanes/vinylalkoxy-silane mixtures are taken up by silica so prepared by both a surface-adsorption process and by absorption within the pores.

Calcium silicate is generally prepared industrially by melting quartz or kieselgur together with calcium carbonate or, respectively, calcium oxide, or by precipitating aqueous sodium metasilicate solutions with water-soluble calcium compounds. The carefully dried product is generally porous and can take up to five times its weight of water or oils.

Porous polyolefins, such as polyethylene (PE) or polypropylene (PP), or copolymers, such as ethylene copolymers with low-carbon-number alkenes, such as propene, butene, hexene, or octene, or ethylene-vinyl acetate (EVA) are prepared by specific polymerization techniques and polymerization processes. The particle sizes are generally from 3 to <1 mm, and the porosity may be above 50% by volume, giving such particles the useful capability of absorbing large amounts of unsaturated organosilane (mixtures) without loss of their free-flowing properties.

Particularly suitable waxes are polyolefin waxes based on low-density polyethylene (LDPE), preferably branched, with long side chains. The melting point and freezing point is generally from 90 to 120° C. In a low-viscosity melt the waxes generally mix readily with the vinylalkoxy silane (mixtures). The hardness of the solidified mixture is generally sufficient for it to be granulated.

The various commercially available forms of carbon black are suitable for producing, for example, black cable sheathing. Carbon black is primarily used in combination with sulfur-containing silanes.

The following methods, inter alia, are available for preparing the “dry liquids”, for example from vinyl-alkoxysilane (mixtures) and carriers:

Mineral carriers or porous polymers are generally preheated, e.g. in a heating cabinet to 60° C., and charged to a cylindrical container which has been flushed with, and filled with, dry nitrogen. The vinylalkoxysilanes/vinylalkoxysilane mixtures are then generally added, and the container is placed in a roller apparatus which rotates it for about 30 minutes. After this time the carrier and the liquid vinylalkoxysilanes/vinylalkoxysilane mixtures have generally formed free-flowing granules with a dry surface, which are preferably stored under nitrogen in containers impermeable to light. Alternatively, the heated carrier may be charged to a mixer flushed with, and filled with, dry nitrogen, e.g. a LODIGE plowshare mixer or a HENSCHEL propeller mixer. The mixing unit can then be started, and the vinyl-alkoxysilanes/vinylalkoxysilane mixtures introduced by spraying via a nozzle once the maximum mixing rate has been reached. Once the addition has been completed, homogenization is generally continued for about 30 minutes and then the product is discharged, e.g. by means of pneumatic conveying operated using dry nitrogen, into containers filled with nitrogen and impermeable to light.

Wax/polyethylene wax in pelletized form with a melting point of from 90 to 120° C. may be melted in portions in a heated vessel equipped with a stirrer, reflux condenser, and liquid feed apparatus, and maintained in the molten state. The apparatus may be flushed with dry nitrogen during the entire preparation process. The liquid vinyl-alkoxysilane (mixtures) may be gradually added to the melt via the liquid feed apparatus, and mixed with the wax by vigorous stirring. The melt is then generally discharged into molds to harden, and the solidified product is granulated. As an alternative, the melt may be allowed to drop onto a cooled molding belt, upon which it solidifies in the form of pastilles which are easy to use.

It is preferable to use a thermoplastic base polymer for the cable compounds. The thermoplastic polymer may have polar groups or may be non-polar. The thermoplastic polymer may in particular be a linear PE polymer, such as LDPE, LLDPE, or mPE. Base polymers having polar groups provide better fire performance, for example, i.e. lower flammability and smoke density, and can accept higher filler levels. Examples of polar groups are hydroxy, nitrile, carbonyl, carboxy, acyl, acyloxy, carboalkoxy, and amino groups, and also halogen atoms, in particular chlorine atoms. Olefinic double bonds or carbon-carbon triple bonds are non-polar. Suitable polymers other than polyvinyl chloride include, for example, copolymers made from one or more olefins and from one or more comonomers which contain polar groups, e.g. vinyl acetate, vinyl propionate, (meth)acrylic acid, methyl (meth)acrylate, ethyl (meth)acrylate, butyl (meth)acrylate, acrylonitrile. The amount of the polar groups in these copolymers is generally from 0.1 to 50 mol %, preferably from 5 to 30 mol %, based on the number of polyolefin units. Particularly suitable base polymers are ethylene-vinyl acetate copolymers (EVAs). An example of a suitable commercially available copolymer contains 19 moles of vinyl acetate units and 81 moles of ethylene units.

The fillers are generally inorganic or mineral, and may advantageously be reinforcing, extending, or else flame-retardant. At least on their surfaces they may have groups which can react with the alkoxy groups of the unsaturated organosilane (mixtures). As a result, silicon atoms bonded to the functional groups become chemically fixed to the surface. In particular, these groups on the surface of the filler are hydroxy groups. Preferred fillers are therefore metal hydroxides with a stoichiometric amoun of hydroxyl groups, metal oxides at various stages of dehydration, which have a substoichiometric proportion of hydroxy groups, including metal oxides having comparatively few residual hydroxy groups, but which can be detected by DRIFT IR spectroscopy. Examples of suitable fillers are aluminum trihydroxide (ATH), aluminum oxide hydroxide (AlOOH.aq), magnesium dihydroxide (MDH), brucite, huntite, hydromagnesite, mica, and montmorillonite. Furthermore, calcium carbonate, talcum and glass fiber may be used as fillers. What are known as “char formers” may also be used, for example ammonium polyphosphate, stannates, borates, talc, or “char formers” combined with other fillers.

Moisture-crosslinked and filled cable compounds according to the present invention are generally produced-by mixing the respective starting components as a melt, preferably while excluding moisture. Conventional heated homogenizing equipment is generally suitable for this purpose, for example kneaders, or for continuous operation, Buss Co-Kneaders, or twin-screw extruders. Alternatively, it is also possible to use a single-screw extruder. The components of the composition of the present invention may be introduced continuously to the extruder, either individually or as partial mixtures, in the required amounts, and heated to a temperature above the melting point of the base polymer. It is advantageous to allow the temperature to rise toward the end of the screw in order to provide a lower viscosity and thereby provide intimate and thorough mixing. The extrudates are advantageously still fluid when introduced to an apparatus for forming insulating or sheathing electrical conductors. The final crosslinking of the filled polymer generally takes place in the convention manner: e.g., in a water bath, in a steam bath, or else through atmospheric moisture at ambient temperature (ambient curing).

The examples below are intended to provide a further description of the invention without limiting the scope of protection.

### EXAMPLE 1

Crosslinking of Filled Silane-Containing HFFR Compounds with a Liquid Unsaturated Organosilane Mixture and with an Unsaturated Organosilane Mixture Bound to Porous Polyethylene or to Precipitated Silica

The starting materials are shown in Table 1.

The crosslinked and filled cable compounds were produced using a single-screw extruder (Thermo Haake, Karlsruhe, DE) (L/D ratio=25, screw diameter 20 mm, 30 rpm).

The HFFR compounds were first dried for at least an hour at 70° C. in a circulating-air drying cabinet. If a liquid vinylsilane or a liquid vinylsilane preparation was used, the HFFR compound was treated with this material for an hour. In contrast, if the silane was used in the form of “dry liquid” the HFFR compound was mixed with this material.

Addition took place in the filled infeed zone of the extruder.

The temperature in the extruder increased from 135 to 170° C. from the feed zone to the end of the screw. The residence time was not more than 150 seconds. Strips were extruded, and test specimens were produced from the strips. The test specimens were crosslinked in a water bath at 80° C. for >6 hours. The results from each of the experiments are shown in Table 2. Table 3 provides a description of relevant analysis methods.

TABLE 1
Definitions and Starting Materials:

| Name | Description | |
|---|---|---|
| Compound 1 | D97/2/24 (silane-containing, MDH filler); Scapa | |
| | Polymerics | |
| Compound 2 | MEGOLON S 500 (silane-containing, ATH filler); | |
| | Scapa Polymerics | |
| Compound 3 | ECCOH 1092 (silane-containing, MDH filler); | |
| | PolyOne | |
| Carrier material 1 | ACCUREL M500 (EVA, VA content = 5%); | |
| | Membrana | |
| Carrier material 2 | ULTRASIL VN3, precipitated silica from Degussa AG | |
| Silane 1 | VTMO (vinyltrimethoxysilane), Degussa AG | |
| Silane 2 | VTEO (vinyltriethoxysilane), Degussa AG | |
| Preparation 1 | Silane 1 | 95.5 |
| | DCUP | 1.5% |
| | DBTL | 3.0% |
| Preparation 2 | Silane 1 | 92.5% |
| | DHBP | 4.5% |
| | DBTL | 3.0% |
| Preparation 3 | Silane 2 | 96.5% |
| | BCUP | 1.5% |
| | DBTL | 2.0% |

| | |
|---|---|
| DCUP | Dicumyl peroxide, Peroxid Chemie |
| DHBP | 2,5-Dimethyl-2,5-di(tert-butylperoxy)-hexane, |
| | Peroxid Chemie |
| BCUP | tert-Butyl cumyl peroxide, Peroxid Chemie |
| DBTL | Dibutyltin dilaurate, Th. Goldschmidt |
| HFFR | Halogen-free flame retardant |
| MDH | Magnesium dihydroxide |
| ATH | Aluminum trihydroxide |
| EVA | Ethylene-vinyl acetate copolymer |
| VA | Vinyl acetate |

TABLE 2
The following characteristic values were determined for the materials of the test specimens produced as
in example 1 and of a comparative experiment*⁾:

| | | | | “Dry liquid” | | | | |
|---|---|---|---|---|---|---|---|---|
| | | | | Content of | | | | |
| | | | | preparation | Amount | | Tensile | Elongation |
| | HFFR | Carrier | Liquid | on carrier | added | Hot set | Strength | At break |
| Preparation | Compound | material | [Pts] | material [%] | [Pts] | [%] | [N/mm²] | [%] |
| 3 | 2 | — | 1.6 | — | — | 60 | 13.8 | 150 |
| 1 | 1 | — | 1.5 | — | — | 70 | 9.0 | 350 |
| 2 | 3 | — | 0.8 | — | — | 60 | 18.8 | 220 |
| 3 | 2 | 1 | — | 45 | 3 | 75 | 12.9 | 165 |
| 1 | 1 | 2 | — | 75 | 2 | 80 | 8.4 | 320 |
| 2 | 3 | 1 | — | 45 | 1.6 | 70 | 17.5 | 240 |
| — | 1*⁾ | — | — | — | — | Fractured | 9.0 | 550 |

TABLE 3
Analysis methods

| | | |
|---|---|---|
| MFR (190° C., 2.16 kg) | [g/10 min] | DIN 1133 |
| Hot set (200° C./15 min/20 N/cm² | [%] | EN ISO 60811-2-1 |
| Tensile strength | [N/mm²] | EN ISO 527 |
| Elongation at break | [%] | EN ISO 527 |
| Bubble formation | [—] | Visual evaluation |

### EXAMPLE 2

Crosslinking of Filled HFFR Compounds Using an Optimized Mixing Specification and Minimizing Adverse “Bubble Formation” on the Cable Surface

During strip extrusion, certain combinations of HFFR compound/organosilane mixture resulted in undesirable and disadvantageous bubble formation on the extrudate surface. The silane application process described above (pre-drying of compound at 70° C. for >1 hour and addition of vinylsilane mixture to the compound followed by a one-hour absorption stage) was varied for compound/organosilane (i.e., 100 Pts of compound and 1 Pt of organosilane). The extruder rotation rates (from 30 to 60 rpm) and melt temperatures (170 to 180°) were also changed. Extrusion took place in a single-screw extruder with L/D ratio=25, screw diameter 20 mm (Thermo Haake, Karlsruhe, DE). Strips were extruded. A compound using MDH as filler was selected as the HFFR compound in order to exclude any effect of possible filler decomposition (decomposition temperature MDH >300° C.), cf. Tables 1 and 4.

TABLE 4
Experiments and Results of Example 2

| | | Rotation | Melt temperature | Bubble formation |
|---|---|---|---|---|
| Compound | Silane | rate [rpm] | [° C.] | [—] |
| 1 | 1 | 30 | 170 | 0.25 |
| | | | 180 | 0.5 |
| | | 60 | 170 | 1 |
| | | | 180 | 1 |
| | 2 | 30 | 170 | 0 |
| | | | 180 | 0.25 |
| | | 60 | 170 | 0 |
| | | | 180 | 0.25 |

The following evaluation criteria were defined:
0 = no bubble formation, smooth surface;
0.25 = hardly any visible bubbles, surface slightly rough;
0.5 = bubble formation clearly visible, rough surface;
1 = marked bubble formation, surface disrupted

Surprisingly, it was found that bubble formation depended on the selection of the type of silane used. Use of silane 2 provided an HFFR compound having significantly lower susceptibility to mechanical or thermal initiation of bubble formation during the production of the cable compounds.

The priority document of the present application, German application 10159952.8, filed Dec. 6, 2001, is incorporated herein by reference.

Obviously, numerous modifications and variations on the present invention are possible in light of the above teachings. It is therefore to be understood that within the scope of the appended claims, the invention may be practiced otherwise than as specifically described herein. What is claimed as new and is intended to be secured by Letters Patent is:

1. A composition comprising:
a thermoplastic base polymer,
a mineral filler,
at least one liquid unsaturated organosilane having at least one hydrolyzable group, optionally supported on a carrier,
at least one free-radical generator (FRG), and
optionally, a crosslinking catalyst.

2. A grafted composition prepared by heating the composition of claim 1 to a temperature sufficient to graft the unsaturated organosilane to the thermoplastic base polymer.

3. A crosslinked composition prepared by exposing the composition of claim 2 to moisture, thereby hydrolyzing the grafted organosilane to form crosslinks.

4. A crosslinked composition prepared by heating and exposing to moisture a starting composition comprising the composition of claim 1,
wherein the starting composition comprises:
(a) at least one thermoplastic base polymer, an FRG, a mineral filler, a crosslinking catalyst, and an unsaturated organosilane, or
(b) at least one thermoplastic base polymer, a mineral filler, a crosslinking catalyst, and an organosilane- and FRG-containing preparation, or
(c) at least one thermoplastic base polymer, a mineral filler, and an organosilane-, FRG-, and crosslinking-catalyst-containing preparation, or
(d) at least one optionally silane-containing thermoplastic base polymer compound prefilled with a mineral filler, an FRG, a crosslinking catalyst, and an unsaturated organosilane, or
(e) at least one optionally silane-containing thermoplastic base polymer compound prefilled with a mineral filler, a crosslinking catalyst, and an organosilane- and FRG-containing preparation, or
(f) at least one optionally silane-containing thermoplastic base polymer compound prefilled with a mineral filler, and an organosilane-, FRG-, and crosslinking-catalyst-containing preparation.

5. The crosslinked composition of claim 3, wherein the unsaturated organosilane is selected from the group consisting of vinyltriethoxysilane, vinyltrimethoxy-silane, vinyltriisopropoxysilane, vinyltri-n-propoxysilane, vinylisobutoxysilane, 3-methacryloxypropyltrimethoxysilane.

6. The crosslinked composition of claim 3, wherein the amount of the unsaturated organosilane is from 0.1 to 10% by weight, based on the total weight of the crosslinked composition.

7. The crosslinked composition of claim 4, wherein the starting composition comprises (b), (c), (e), or (f) and the organosilane-containing preparation is present in the starting composition in an amount of from 0.5 to 3% by weight, based on the total weight of the crosslinked composition.

8. The crosslinked composition of claim 3, wherein the FRG is present in an amount of from 0.01 to 0.45 by weight, based on the total weight of the crosslinked composition.

9. The crosslinked composition of claim 3, wherein the FRG is selected from the group consisting of dicumyl peroxide, tert-butyl peroxypivalate, di-tert-butyl peroxide, tert-butyl 2-ethylperoxyhexanoate, and tert-butyl cumyl peroxide.

10. The crosslinked composition of claim 3, wherein the crosslinked composition further comprises a crosslinking catalyst comprising an organometallic compound selected from the group consisting of dibutyltin dilaurate, dioctyltin dilaurate, and stannous octanoate.

11. The crosslinked composition of claim 3, wherein the crosslinked composition further comprises 0.005 to 0.2% by weight, based on the total weight of the crosslinked composition, of a crosslinking catalyst.

12. The crosslinked composition of claim 3, wherein the unsaturated organosilane is supported on a carrier comprising a porous polymer selected from the group consisting of polypropylene, a polyolefin, a copolymer of ethylene and a low-carbon-number alkene, an ethylene-vinyl acetate copolymer, a high-density polyethylene, a low-density polyethylene, and a linear low-density polyethylene.

13. The crosslinked composition of claim 12, wherein the porous polymer has a pore volume of from 30 to 90%.

14. The crosslinked composition of claim 12, wherein the porous polymer has the form of a pellet.

15. The crosslinked composition of claim 3, wherein the unsaturated organosilane is supported on a carrier comprising fumed silica.

16. The crosslinked composition of claim 3, wherein the unsaturated organosilane is supported on a carrier comprising precipitated silica.

17. The crosslinked composition of claim 3, wherein the unsaturated organosilane is supported on a carrier comprising calcium silicate.

18. The crosslinked composition of claim 3, wherein the unsaturated organosilane is supported on a carrier comprising a wax.

19. The crosslinked composition of claim 18, wherein the wax is a low-density polyethylene wax.

20. The crosslinked composition of claim 3, wherein the unsaturated organosilane is supported on a carrier comprising a carbon black.

21. The crosslinked composition of claim 3, wherein the unsaturated organosilane is supported on a carrier, and the carrier is present in an amount of from 0.7 to 7% by weight, based on the weight of the crosslinked composition.

22. The crosslinked composition of claim 3, wherein the unsaturated organosilane is supported on a carrier, and the carrier binds the unsaturated organosilane component physically or chemically, or by encapsulating the unsaturated organosilane.

23. The crosslinked composition of claim 3, wherein the unsaturated organosilane is supported on a carrier, and the carrier is swollen by the unsaturated organosilane.

24. The crosslinked composition of claim 3, wherein the thermoplastic base polymer comprises a non-polar polyolefin or a polyvinyl chloride, or a copolymer prepared by polymerizing from one or more olefins with one or more comonomers which contain polar groups.

25. The crosslinked composition of claim 3, wherein the mineral filler comprises a metal hydroxide with a stoichiometric or substoichiometric amount of hydroxy groups, or a metal oxide having residual hydroxy groups.

26. A cable comprising a metallic conductor or conductor bundle coated with the crosslinked composition of claim 3.

27. A cable comprising a metallic conductor coated with the crosslinked composition of claim 3.

28. A process for preparing a cable, comprising:
adding at least one thermoplastic base polymer and at least one mineral filler, or at least one optionally silane-containing thermoplastic base polymer prefilled with a mineral filler, and
at least one crosslinking catalyst, at least one free-radical generator (FRG), and at least one unsaturated organosilane, or a mixture of an unsaturated organosilane, FRG, and/or crosslinking catalyst, to an extrusion unit, thereby forming a mixture;
extruding the mixture onto a metallic conductor or conductor bundle, thereby extrusion coating the metallic conductor or conductor bundle with the mixture; and
crosslinking the extrusion coating in the presence of moisture.

29. A method of preparing a cable, comprising:
coating a metallic conductor or conductor bundle with the composition of claim 1;
heating the coated metallic conductor or conductor bundle at a temperature sufficient to graft the unsaturated organosilane to the thermoplastic base polymer; and
exposing the grafted coating to moisture, thereby crosslinking the coating.

30. A method of preparing a cable, comprising:
coating a metallic conductor or conductor bundle with the grafted composition of claim 2; and
exposing the grafted coating to moisture, thereby crosslinking the coating.

31. The crosslinked composition of claim 3, wherein the mineral filler is a reinforcing, extending, or flame-retardant mineral filler.

32. A cable comprising a conductor bundle or isolated conductor bundle jacketed with a moisture-crosslinked, filled cable composition, prepared by the method of claim 28.
